(19) United States
(12) Patent Application Publication
(10) Pub. No.: US 2015/0207368 A1
(43) Pub. Date: Jul. 23, 2015

(54) MOTORIZED SERVO DEVICE USING CASELESS MOTOR

(71) Applicant: Tricore Corporation, Huatan Township (TW)

(72) Inventors: Yen-Fu CHEN, Huatan Township (TW); Chi-Hsing HO, Huatan Township (TW)

(73) Assignee: Tricore Corporation, Huatan Township (TW)

(21) Appl. No.: 14/162,006

(22) Filed: Jan. 23, 2014

(51) Int. Cl. H02K 1/18; H02K 7/116; H02K 5/04

(52) U.S. Cl. CPC H02K 1/185; H02K 5/04; H02K 7/116

(57) ABSTRACT

A motorized servo device includes a case and a caseless motor. The case has a cylinder surface and an accommodating space defined by the cylinder surface. The caseless motor has a stator and a rotator, which are installed in the accommodating space coaxially and one of which contacts the cylinder surface directly. As a result, the motorized servo device of the present invention can output higher power than a conventional motorized servo device having a same volume of the motorized servo device of the present invention and is relatively easier in assembly and tolerance control.

### BACKGROUND OF THE INVENTION

1. Field of the Invention

The present invention relates generally to motorized servo devices and more particularly, to a motorized servo device using a caseless motor.

2. Description of the Related Art

A motorized servo device, which is so called servomotor, is adapted in an automatic device to serve as a power source for a particular function and primarily used at the part requiring precise control of angular position. At present the motorized servo device is not only widely applied in remote control model and also acts as one of the critical components in robot industry.

The conventional motorized servo device primarily comprises a motor, a reduction gear set for transmitting the rotational kinetic energy of the motor to an output shaft, an angular sensor for detecting the angular position of the output shaft, and a circuit board for receiving the signal of the angular sensor and controlling the motor. The aforesaid components of the motorized servo device are installed in a housing which is composed of a case, a top cover and a bottom cover. For the motor installed inside the case of the housing, commercially available standard products are always used. This means the motor installed in the case further has its own case.

However, if the case of the motorized servo device can also serve as the case of the aforesaid standard motor, the original case of the standard motor can be removed to spare a few more space for a bigger sized stator and/or rotator of the motor. In this way, the case can accommodate relatively larger stator or rotator to raise the output power of the motorized servo device without increasing the volume of the motorized servo device.

### SUMMARY OF THE INVENTION

The present invention has been accomplished in view of the above-noted circumstances. It is an objective of the present invention to provide a motorized servo device which can output higher power than the conventional motorized servo device under a condition of same volume.

It is another objective of the present invention to provide a motorized servo device which is relatively easier in assembly and tolerance control.

To attain the above objectives, the present invention provides a motorized servo device which comprises a case and a caseless motor. The case has a cylinder surface and an accommodating space defined by the cylinder surface. The caseless motor has a stator and a rotator, which are installed in the accommodating space coaxially and one of which contacts the cylinder surface directly.

In other words, the caseless motor used in the present invention doesn't have its own case for accommodating the stator and the rotator. That is, the stator and the rotator of the caseless motor of the present invention are directly housed and held by the case of the motorized servo device. In this way, compared with the conventional motorized servo device having a same case with a same space for accommodating the motor, the motorized servo device of the present invention can accommodate relatively larger stator and rotator in the same space. Therefore, the motorized servo device of the present invention can output higher power than the conventional motorized servo device having a volume equal to that of the motorized servo device of the present invention. Besides, the stator and the rotator of the present invention are directly installed in the accommodating space of the case of the motorized servo device without being installed in a case of the motor before installation, so the motorized servo device of the present invention is easier in assembly and tolerance control than the conventional motorized servo device.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a partial assembled perspective view of a motorized servo device according to a preferred embodiment of the present invention;

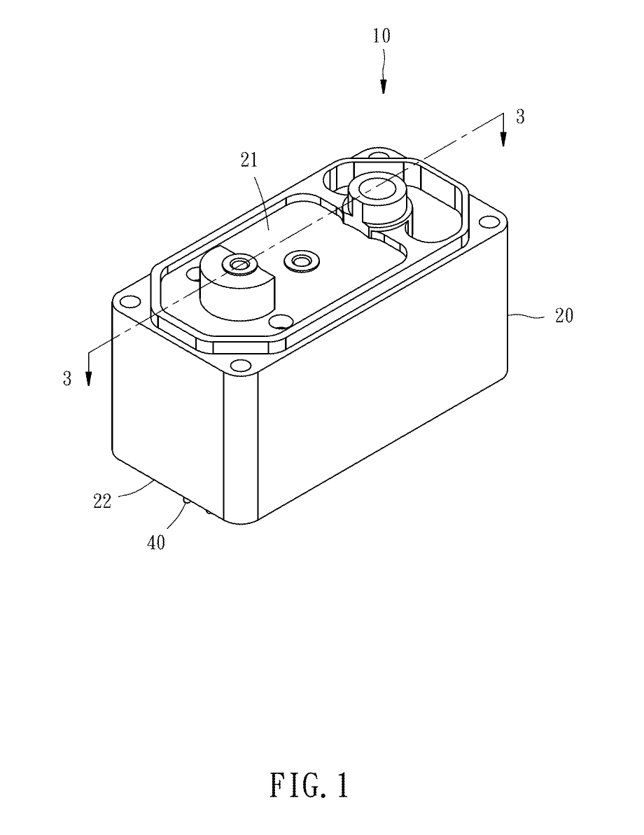

FIG. 2 is a partial exploded perspective view of the motorized servo device according to the preferred embodiment of the present invention;

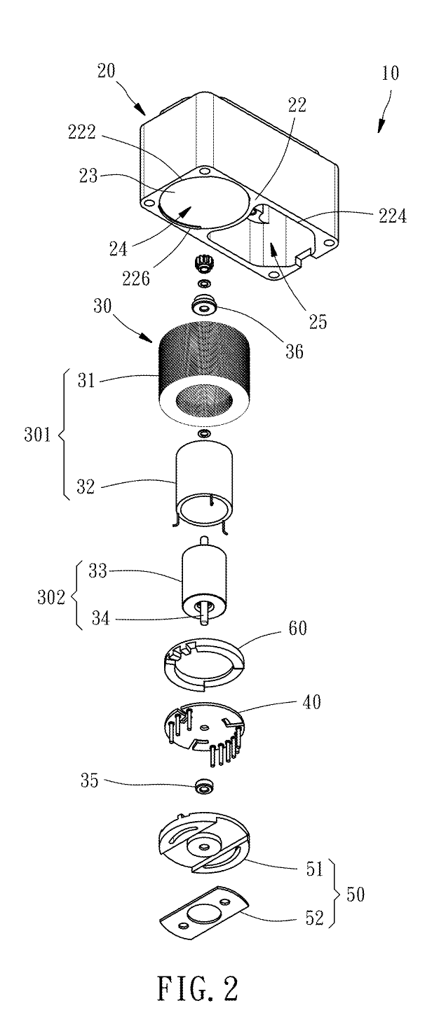

FIG. 3 is a sectional view taking along line 3-3 in FIG. 1; and

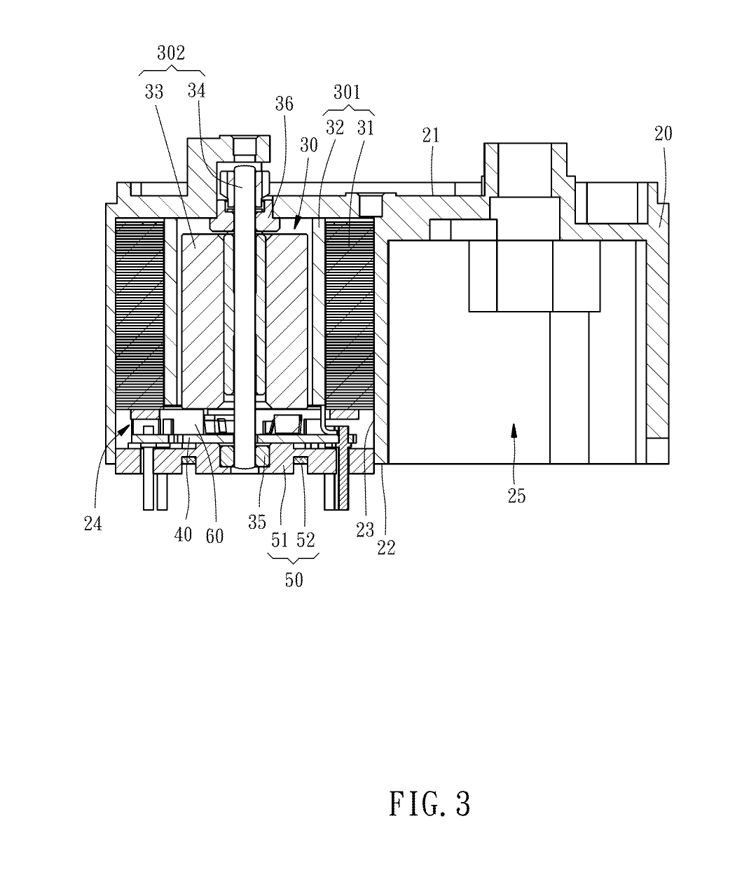

FIG. 4 is the bottom view of FIG. 1.

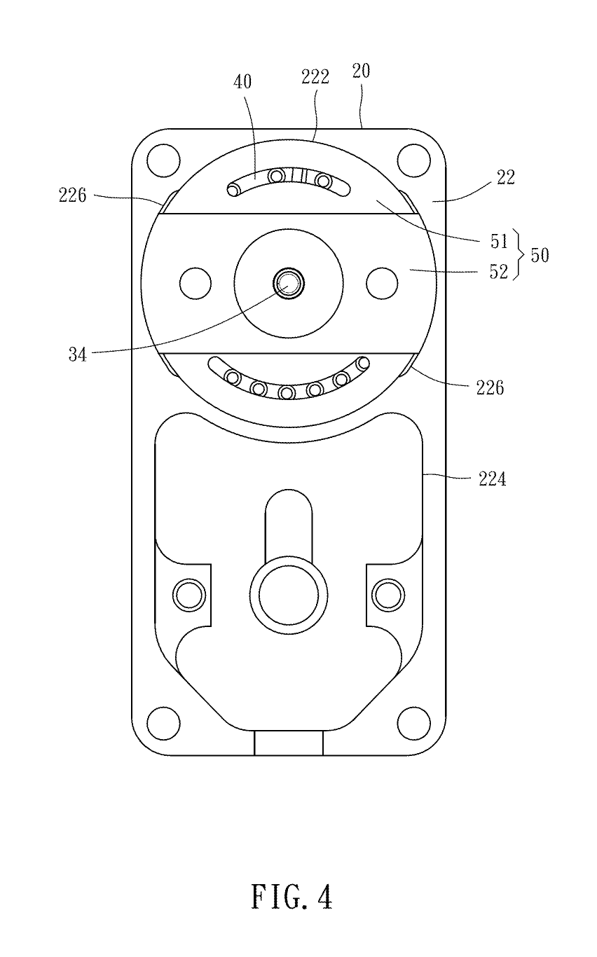

### DETAILED DESCRIPTION OF THE INVENTION

Referring to the figures, primary components of a motorized servo device 10 according to a preferred embodiment of the present invention are shown in the figures, and the rest components of the motorized servo device 10, which are not quite related with the improved features of the present invention, are not shown in the figures. As shown in the figures, the motorized servo device 10 comprises a case 20, a caseless motor 30, a circuit board 40, a bottom cap 50 and a spacer 60.

The case 20 is formed integrally and provided with a top surface 21 and a bottom surface 22 having a circular opening 222. A cylinder surface 23 and an accommodating space 24 defined by the cylinder surface 23 are located inside the case 20 and axially aligned and communicated with the opening 222. The caseless motor 30, the circuit board 40 and the spacer 60 are installed in the accommodating space 24. The bottom cap 50 is fixed at the opening 222. This part will be specified later.

The case 20 is provided at the inside thereof with a further accommodating space 25 with a further opening 224 at the bottom surface 22 of the case 20. The further accommodating space 25 is adapted for the installation of an angular sensor (not shown). The motorized servo device 10 can further comprise a bottom cover (not shown) attached at the bottom surface 22 for covering the further accommodating space 25. In addition, the motorized servo device usually comprises a reduction gear set (not shown) mounted on the top surface 21 of the case 20 and a top cover (not shown) covering the reduction gear set.

The caseless motor 30 comprises a stator 301 and a rotator 302, which are installed in the accommodating space 24 coaxially. The stator 301 comprises many annular silicon steel plates 31 and a sleeve 32. The rotator 302 comprises a magnet 33 and a spindle 34. Many coils (not shown) are wound around the silicon steel plates 31. The outer rims of the silicon steel plates 31 contact the cylinder surface 23 directly. The sleeve 32 is attached to the inner rims of the silicon steel plates 31 and electrically connecting the coils wound around the silicon steel plates 31 with the circuit board 40. The magnet 33 is rotatably placed in the sleeve 32. The spindle 34 is fixed in the center of the magnet 33. An end of the spindle 34 is rotatably attached to the bottom cap 50 by means of a bearing 35. The other end of the spindle 34 is rotatably attached to the case 20 by means of another bearing 36 and protruding out from the top surface 21 of the case 20. As a result, when the stator 301 is electrified, the rotator 302 will rotate and the spindle 34 will drive the reduction gear set mounted on the top surface 21 of the case 20 to drive a rotatable object (not shown).

The circuit board 40 and the spacer 60 are placed in between the bottom cap 50 and the caseless motor 30. The spacer 60 is located between the circuit board 40 and the stator 301 of the caseless motor 30. In this embodiment, the bottom surface 22 of the case 20 has two arc-shaped positioning slots 226 communicated with the opening 222; the bottom cap 50 has a main body 51 fitted with the opening 222, and a positioning plate 52 embedded in the main body 51 and the positioning slots 226 and fastened to the case 20 by welding or other connecting ways. It will be appreciated that the configuration design of the bottom cap 50 and the way the bottom cap 50 is fixed at the opening 222 of the case 20 are not limited to those provided in this embodiment.

Because the caseless motor 30 doesn't comprise a case for accommodating the stator 301 and the rotator 302 and the stator 301 and the rotator 302 are housed and held by the case 20, compared with the conventional motorized servo device having a same size of the motorized servo device case, the motorized servo device 10 of the present invention can accommodate relatively lager stator and rotator so as to output relatively higher power. Besides, the components of the caseless motor 30 are directly installed in the accommodating space 24 of the case 20 without being installed in a motor case beforehand, so the motorized servo device 10 of the present invention is easier in assembly and tolerance control than the conventional motorized servo device.

It will be appreciated that the caseless motor of the motorized servo device provided by the present invention is not limited to the type that the stator surrounds the rotator. The motorized servo device provided by the present invention can use another type of motor wherein the rotator surrounds the stator; in this case, the rotator, instead of the stator, contacts the cylinder surface of the case.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A motorized servo device comprising:
a case having a cylinder surface and an accommodating space defined by the cylinder surface; and
a caseless motor having a stator and a rotator, which are installed in the accommodating space coaxially and one of which contacts the cylinder surface directly.

2. The motorized servo device as claimed in claim 1, wherein the stator contacts the cylinder surface directly.

3. The motorized servo device as claimed in claim 1, wherein the case is formed integrally.

4. The motorized servo device as claimed in claim 1, wherein the case is provided with a top surface and a bottom surface having an opening; the accommodating space is communicated with the opening; a bottom cap is fixed at the opening.

5. The motorized servo device as claimed in claim 4, wherein the bottom surface of the case further has two positioning slots communicated with the opening; the bottom cap has a main body fitted with the opening and a positioning plate embedded in the main body and the positioning slots.

6. The motorized servo device as claimed in claim 4, further comprises a circuit board located between the bottom cap and the caseless motor and electrically connected with the caseless motor.

7. The motorized servo device as claimed in claim 4, wherein the rotator of the caseless motor has a spindle; an end of the spindle is rotatably attached to the bottom cap; the other end of the spindle protrudes out from the top surface of the case for driving a reduction gear set mounted on the top surface.
